(19) United States
(12) Patent Application Publication
(10) Pub. No.: US 2021/0120661 A1
(43) Pub. Date: Apr. 22, 2021

(54) TARGET FOR PROTON-BEAM OR NEUTRON-BEAM IRRADIATION AND METHOD FOR GENERATING RADIOACTIVE SUBSTANCE USING SAME

(71) Applicant: KANEKA CORPORATION, Osaka (JP)

(72) Inventors: Atsushi Tatami, Osaka (JP); Masamitsu Tachibana, Osaka (JP); Mutsuaki Murakami, Osaka (JP)

(73) Assignee: KANEKA CORPORATION, Osaka (JP)

(21) Appl. No.: 16/620,628

(22) PCT Filed: Jun. 6, 2018
(86) PCT No.: PCT/JP2018/021650

§ 371 Date: Dec. 9, 2019

(30) Foreign Application Priority Data
Jun. 9, 2017 (JP) 2017-114328

(51) Int. Cl. H05H 6/00; G21G 1/10; G21G 1/00

(52) U.S. Cl. CPC H05H 6/00; G21G 1/10; G21G 2001/0036; G21G 2001/0042; G21G 1/001

(57) ABSTRACT

An object of the present invention is to realize a target, for neutron-beam or proton-beam irradiation, that can withstand prolonged beam irradiation. A target for proton-beam or neutron-beam, comprising a graphite film (A) having a thermal conductivity of 500 W/mK or more in a direction parallel to an a-b plane of a graphite layer at 25° C.; and a layer (B) of a starting material for producing a radioactive substance, and being a laminate of the graphite film (A) and the layer (B). A density of the graphite film (A) is preferably 1.8 to 2.26 g/cm³. A tensile strength of the graphite film (A) is preferably 5 MPa or more.

### TECHNICAL FIELD

The present invention relates to a target for proton-beam or neutron-beam irradiation.

### BACKGROUND ART

In the medical field, radioactive isotopes (hereinafter referred to as RI) are utilized for diagnosis of diseases, for example, PET (Positron Emission Tomography) diagnosis (Non-patent Document 1). Among the radioactive isotopes, particularly technetium (^{99m}Tc) is utilized for scintigraphy of the brain, thyroid gland, and bone and for scanning by 40 million times a year worldwide.

Molybdenum (hereinafter, ⁹⁹Mo) which is a parent nuclide of technetium (^{99m}Tc), can be generated from ²³⁵U which is an isotope of uranium. However, Canadian Chalk River Reactor, which had supplied ⁹⁹Mo by 35% to 40% of the amount of ⁹⁹Mo required in the world, stopped producing of ⁹⁹Mo in 2016, and thus a problem has arisen that the supply of ⁹⁹Mo is insufficient (Non-patent Document 2).

Meanwhile, as a method for producing ⁹⁹Mo, the production of ⁹⁹Mo is also being investigated in which molybdenum-100 (¹⁰⁰Mo), a molybdenum isotope contained in natural molybdenum, is used as a starting material (starting material for producing a radioactive substance) and an accelerator is used. Examples of a method for producing ⁹⁹Mo from ¹⁰⁰Mo as a starting material mainly include a method using a neutron beam and a method using a proton beam. In the method using a neutron beam, fast neutrons having energy of 9.5 to 25 MeV are generated, a starting material target containing ¹⁰⁰Mo is irradiated with the fast neutrons, and ⁹⁹Mo is generated by a (n, 2n) reaction in which two neutrons are released from one neutron (for example, Patent Document 1). In addition, in the method using a proton beam, a starting material target containing ¹⁰⁰Mo is irradiated with a proton beam, and ⁹⁹Mo is generated by a (p, 2n) reaction (for example, Non-Patent Documents 2 and 3 and Patent Document 2).

In a method for producing ⁹⁹Mo from ¹⁰⁰Mo as a starting material using an accelerator, a powder containing ¹⁰⁰Mo is compressed and formed into a pellet shape and sintered in a hydrogen atmosphere to obtain a molybdenum plate and the molybdenum plate is brazed to a composite substrate of alumina and copper, thereby producing a target for beam irradiation in Non-Patent Document 2.

In addition, as another method for producing a target for beam irradiation, a method is known in which ¹⁰⁰Mo is laminated on the surface of a tantalum substrate by electrophoretic deposition (electrophoretic deposition or electrophoretic electrodeposition) method to obtain a target for beam irradiation (Non-patent Document 3).

A method utilizing molybdenum oxide as a starting material for producing a radioactive substance has also been reported (Patent Document 3) in addition to the method using ¹⁰⁰Mo (namely, metal molybdenum) as described above.

### PRIOR ART DOCUMENTS

### Patent Documents

[Patent Document 1] JP2010-223937A
[Patent Document 2] WO2011/132265
[Patent Document 3] WO2016/063774

### Non Patent Documents

[Non Patent Document 1] Review of Accelerator Science and Technology 2009, 2, 1-15.
[Non Patent Document 2] Physics Procedia 2015, 66, 383-395.
[Non Patent Document 3] The Journal of Nuclear Medicine 2014, 55, 1017-1022.
[Non Patent Document 4] Journal of American Chemical Society 2014, 136, 6083-6091.

### SUMMARY OF THE INVENTION

### Problems to be Solved by the Invention

In a method for irradiating a target containing a starting material such as ¹⁰⁰Mo for producing a radioactive substance with a neutron beam or a proton beam, there is concern about damage to the target (damage to the substrate and the starting material for producing a radioactive substance) due to high energy beam irradiation. Particularly in a case in which a substance having a low melting point is used as a starting material for producing a radioactive substance, the layer of the starting material for producing a radioactive substance can be damaged. Hence, an object of the present invention is to realize a target, for neutron-beam or proton-beam irradiation, that can withstand even prolonged beam irradiation.

### Solutions to the Problems

The present inventors have considered that the object can be achieved if a substrate which diffuses the heat at the portion irradiated with a beam, namely, a substrate having a high thermal conductivity, is adopted as a target substrate. Furthermore, the present inventors have considered that a light element such as beryllium and carbon should be used as a material for the target substrate from the viewpoint of being hardly radioactivated when the target is irradiated with a neutron beam or proton beam. However, beryllium is significantly expensive and there is a problem that dust containing beryllium is toxic to the human body. Accordingly, the present inventors have found out that damage (deformation and the like) of the target can be prevented by the use of graphite exhibiting favorable thermal conductivity as a material for a target substrate, and the present invention has been thus completed.

The present invention is as follows.

[1] A target for proton-beam or neutron-beam irradiation, comprising:

a graphite film (A) having a thermal conductivity of 500 W/mK or more at 25° C. in a direction parallel to an a-b plane of a graphite layer; and

a layer (B) of a starting material for producing a radioactive substance,

wherein the target is a laminate of the graphite film (A) and the layer (B).

[2] The target according to [1], wherein a density of the graphite film (A) is 1.8 to 2.26 g/cm³.
[3] The target according to [1] or [2], wherein a tensile strength of the graphite film (A) is 5 MPa or more.
[4] The target according to anyone of [1] to [3],

wherein a ratio RG/RC is 4 or more, and

wherein RG is a Raman band intensity appearing at 1575 to 1600 cm⁻¹ and RC is a Raman band intensity appearing at 1330 to 1360 cm⁻¹, each obtained from a measurement of the graphite film (A) by Raman spectroscopy.

[5] The target according to anyone of [1] to [4], wherein a thickness of the graphite film (A) is 0.1 to 50 μm.
[6] The target according to anyone of [1] to [5], wherein the starting material is a metal and/or a metal oxide.
[7] The target according to anyone of [1] to [6], wherein the starting material is molybdenum-100 metal and/or an oxide of molybdenum-100 metal.
[8] The target according to [7], wherein the starting material further comprises a molybdenum isotope metal and/or an oxide of a molybdenum isotope.
[9] The target according to anyone of [1] to [8], further comprising a metal layer (C), wherein the graphite film (A) and the layer (B) are laminated via the metal layer (C).
[10] The target according to [9], wherein the metal layer (C) is at least one selected from the group consisting of aluminum, titanium, nickel, iron, copper, tantalum, tungsten, gold, silver, platinum, and ruthenium.
[11] The target according to [9] or [10], wherein a thickness of the metal layer (C) is 1 μm or less.
[12] A method for generating a radioactive substance, comprising irradiating the target according to any one of [1] to [11] with a proton beam or a neutron beam.

### Effects of the Invention

The present invention is a target in which a graphite film having a favorable thermal conductivity is laminated on a layer of a starting material for manufacturing a radioactive substance, thus heat can be efficiently diffused when the target is irradiated with a proton beam or a neutron beam and damage such as deformation of the target can be prevented. In addition, the target substrate is formed of graphite, thus the radioactivation of the target substrate is suppressed even after prolonged beam irradiation and the exposure of the operator to radiation at the time of target exchange is diminished.

### BRIEF DESCRIPTION OF THE DRAWINGS

FIG. 1 is a schematic diagram illustrating a configuration example of a target of the present invention.

FIG. 2 is a schematic diagram of a heat resistance testing apparatus used in Examples to be described later.

### MODE FOR CARRYING OUT THE INVENTION

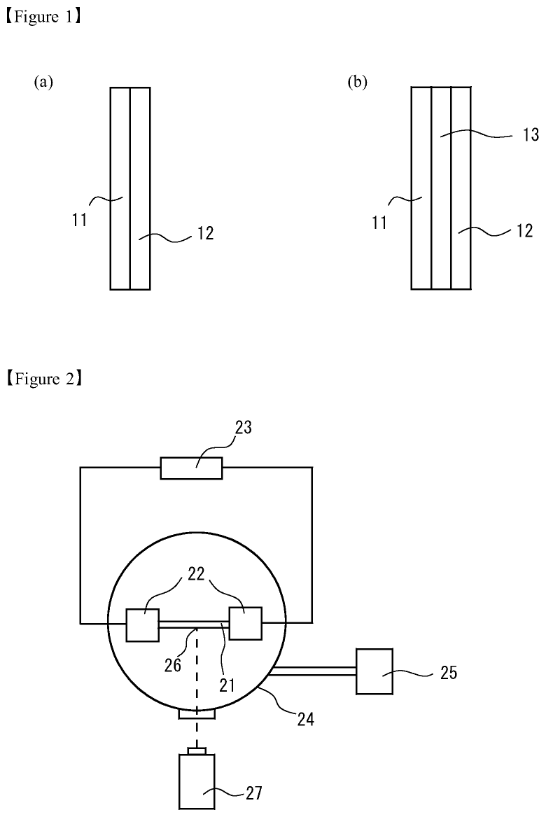

The target of the present invention is a target to be irradiated with a proton beam or a neutron beam and is a laminate of a graphite film (A) and a layer of a starting material for producing a radioactive substance (B). The target of the present invention is characterized in that a thermal conductivity of the graphite film (A) in a direction parallel to an a-b plane of a graphite layer at 25° C. is 500 W/mK or more, thus heat generated by the beam irradiation can be quickly diffused from a target substrate (namely, the graphite film (A)) and the layer of a starting material for producing a radioactive substance (B), and damage of the target can be prevented. The graphite film (A) in the present invention is a graphite layer having a thermal conductivity of 500 W/mK or more in an a-b plane direction at 25° C., namely, a graphite film having a thermal conductivity of 500 W/mK or more in the direction parallel to the a-b plane of the graphite layer at 25° C. An example of a configuration of the target of the present invention is illustrated in FIG. 1. In the target of the present invention, a graphite film (A) 11 and a layer of a starting material for producing a radioactive substance (B) 12 are laminated as illustrated in FIG. 1(a). In a preferred aspect, the graphite film (A) 11 and the layer of a starting material for producing a radioactive substance (B) 12 are laminated via a metal layer (C) 13 as illustrated in FIG. 1(b). In FIG. 1, the layers (A), (B), and (C) are illustrated as layers constituting the target of the present invention. However, in the target of the present invention, layers other than the layers (A), (B), and (C) may be laminated as long as the effects of the present invention are not impaired. Hereinafter, the graphite film (A), the layer of a starting material for producing a radioactive substance (B), and the metal layer (C) will be described in this order.

(1) Graphite Film (A)

(1-a) Thermal Conductivity in Direction Parallel to a-b Plane of Graphite Layer

In the present invention, the thermal conductivity of the graphite film (A) in a direction parallel to the a-b plane of a graphite layer at 25° C. is 500 W/mK or more. Usually, when a target is irradiated with a proton beam or a neutron beam (hereinafter these are together simply referred to as “beam” in some cases), a site irradiated with the beam is locally heated and cooled and thus the target is deformed. When the thermal conductivity of the graphite film (A) is in the above range, a local heat of the target can be quickly dispersed to the surroundings and a temperature change of the target can be diminished. The thermal conductivity is preferably 1000 W/mK or more, more preferably 1200 W/mK or more, still more preferably 1500 W/mK or more, particularly preferably 1800 W/mK or more, and most preferably 1950 W/mK or more. The upper limit of the thermal conductivity is not particularly limited and is, for example, 2200 W/mK or less and may be 2100 W/mK or less.

The thermal conductivity of the graphite film (A) in the direction parallel to the a-b plane of the graphite layer is calculated by the following Equation (1).

λ=α×d×Cp (1)

In Equation (1), λ denotes the thermal conductivity of the graphite film (A) in the direction parallel to the a-b plane of the graphite layer, α denotes a thermal diffusivity of the graphite film (A) in the direction parallel to the a-b plane of the graphite layer, d denotes a density of the graphite film (A), and Cp denotes a specific heat capacity of the graphite film (A). The density, thermal diffusivity, and specific heat capacity of the graphite film (A) are determined by the methods to be described below.

The thermal diffusivity of the graphite film (A) in the direction parallel to the a-b plane of the graphite layer can be measured using a commercially available thermal diffusivity measuring apparatus based on the optical alternating current method (for example, “LaserPit” manufactured by ULVAC RIKO, Inc.) in a case in which a thickness of the graphite film exceeds 3 μm. For example, graphite cut into a shape of 4 mm×40 mm is measured at 25° C. under alternating current conditions of 10 Hz. Meanwhile, in a case in which a thickness of the graphite film is 3 μm or less, the thermal diffusivity of the graphite film (A) in the direction parallel to the a-b plane of the graphite layer is inaccurate when being measured using a thermal diffusivity measuring apparatus by a periodic heating method such as “LaserPit” manufactured by ULVAC RIKO, Inc. Hence, a measurement was performed using a periodic heating radiation temperature measurement method (Thermowave Analyzer TA3 manufactured by BETHEL Co., Ltd.) as a second measurement method. This is an apparatus which performs periodic heating using a laser and measures the temperature using a radiation thermometer, is completely not in contact with the graphite sheet at the time of the measurement, and thus can measure even the thermal diffusivity of a sample having a graphite sheet thickness of 3 μm or less. In order to confirm a reliability of the measured values by both apparatuses, several samples were measured using both apparatuses and the measured values were confirmed to coincide with each other. In the case of the apparatuses manufactured by BETHEL Co., Ltd., a frequency of periodic heating can be changed in a range up to 800 Hz. In other words, this apparatus is characterized in that a measurement of temperature to be usually performed in a contact manner using a thermocouple is performed using a radiation thermometer and a measuring frequency can be changed. In principle, a constant thermal diffusivity should be measured even when the frequency is changed. Hence, the frequency was changed and the measurement was performed in the measurement using the present apparatus. In a case in which a sample having a thickness of 3 μm or less was measured, the measured values often varied in the measurement at 10 Hz and 20 Hz but the measured values were almost constant in the measurement at from 70 Hz to 800 Hz. Hence, values (values at 70 Hz to 800 Hz) to be constant regardless of the frequency were taken as the thermal diffusivity.

The specific heat capacity of the graphite film (A) is measured at from 20° C. to 260° C. under a heating condition of 10° C./min using a differential scanning calorimeter DSC220CU which is a thermal analysis system manufactured by SII Nano Technology Inc.

(1-b) Density

The density of the graphite film (A) is preferably 1.8 g/cm³ or more from the viewpoint of securing the thermal conductivity of the graphite film (A) and preventing scattering of the beam at the time of beam irradiation. In addition, the fact that the density of the graphite film (A) is 1.8 g/cm³ or more is particularly advantageous when a target is fabricated by an electrodeposition method (electrophoretic electrodeposition method). In general, in a technique for laminating a metal layer on a substrate by an electrodeposition method, a metal is used as an electrode (substrate), and there is no example in which graphite is used. For example, Non-Patent Document 4 relates to a technique for electrochemically peeling off graphene from graphite in an aqueous solution of an inorganic salt but does not relate to a technique for laminating a metal layer on graphite. However, referring to Non-Patent Document 4, a lamination of a metal layer on a usual graphite substrate by an electrodeposition method is considered to be difficult. Examples of the reason for this include the fact that water enters the gaps of graphite to generate hydrogen by electrolysis, and the graphite peels off and the fact that graphite peels off by the influence of water and ions which have entered the graphite film when usual graphite having a low density is used as an electrode. The density of the graphite film (A) is more preferably 1.9 g/cm³ or more and still more preferably 2.0 g/cm³ or more. A preferred upper limit of the density of the graphite film (A) is 2.26 g/cm³ or less, which is a theoretical value of a graphite single crystal, and may be 2.20 g/cm³ or less.

The density of the graphite film is calculated by measuring a weight and thickness (to be described later) of a sample of the graphite film cut into a predetermined shape (for example, 100 mm×100 mm) and dividing the measured weight value by the calculated volume value (sample area×thickness).

(1-c) Thickness

A thickness of the graphite film (A) is preferably 0.1 to 50 μm. The thickness of the graphite film is preferably 0.1 μm or more from the viewpoint of securing strength. When the thickness is 0.1 μm or more, the handleability of the graphite film (A) is favorable in a case in which the target is produced by the electrodeposition method. The thickness of the graphite film (A) is more preferably 0.5 μm or more, still more preferably 1 μm or more, and particularly preferably 2 μm or more. When the graphite film is too thick, the quantity of heat received by beam irradiation increases and there is thus the danger that the temperature of the target increases. In addition, when the graphite film is too thick, the beam cannot pass through the graphite film, and ion implantation occurs inside the graphite film, and there is thus the danger that the substrate is destroyed. Consequently, the thickness of the graphite film (A) is preferably 50 μm or less, more preferably 40 μm or less, and still more preferably 30 μm or less. The thickness of the graphite film (A) is preferably 0.1 to 50 μm from the viewpoint of realizing a preferred range of the density of the graphite film (A).

The thickness of the graphite film (A) can be measured by the following method. The thickness of graphite cut into a shape of 50 mm×50 mm is measured at arbitrary 10 points in a thermostatic chamber at 25° C. using a thickness gauge (HEDENH: AIN-CERTO manufactured by HEIDENHAIN) and the average value of the measured values is taken as the thickness of the graphite film (A).

(1-d) Tensile Strength

A tensile strength of the graphite film (A) is preferably 5 MPa or more. When the starting material for producing a radioactive substance (B) or the metal layer (C) are formed on the graphite film (A), there is a case in which the graphite film (A) is fixed to a specially manufactured jig. At this time, the tensile strength of the graphite film (A) is preferably 5 MPa or more so that the graphite film (A) is not fractured during the operation. The tensile strength of the graphite film (A) is more preferably 5 MPa or more, still more preferably 10 MPa or more, and particularly preferably 15 MPa or more. The upper limit of the tensile strength of the graphite film (A) is not limited but is usually 50 MPa or less.

The tensile strength of the graphite film (A) was measured as follows. First, the produced graphite film (A) was cut into a size of 10×40 mm, and both ends thereof were reinforced with a polyimide tape having a thickness of 12.5 μm. The produced sample for a measurement was set on a vertical type electrically driven measurement stand (EMX-1000N manufactured by IMADA CO., LTD.). A tensile speed was set to 5 mm/min, and the tensile strength was measured using a digital force gauge (ZTA-5N manufactured by IMADA CO., LTD.).

(1-e) Raman Band Intensity Ratio R (=RG/RC)

Whether the graphite film (A) is carbonaceous or graphite can be evaluated by laser Raman spectroscopy. In the laser Raman spectroscopic measurement, a band (RG) based on a graphite structure appears at 1575 to 1600 cm⁻¹ and a band (RC) based on an amorphous carbon structure appears at 1330 to 1360 cm⁻¹. The graphite film (A) in the present invention means a graphite film in which the RG is the highest as compared to other bands, but the relative intensity ratio RG/RC of the two bands (hereinafter referred to as the Raman intensity ratio R) is preferably 4 or more, more preferably 30 or more, and still more preferably 50 or more.

(2) Layer of starting material for producing radioactive substance (B) Radioactive substances refer to all substances which emit radiation and are preferably a substance which emits α rays, β rays, or γ rays, and examples thereof include ⁹⁹Mo that emits β rays. Moreover, a starting material for producing a radioactive substance is a substance from which the radioactive substance is produced by being irradiated with a proton beam or a neutron beam. The starting material is preferably molybdenum-100 (¹⁰⁰Mo) in a case in which the radioactive substance is ⁹⁹Mo described above.

The starting material for producing a radioactive substance may be a metal, a metal oxide, or a mixture of these and is preferably molybdenum-100 metal (meaning molybdenum-100 in a metal state) and/or an oxide of molybdenum-100. An oxide of molybdenum-100 has a lower melting point than molybdenum-100 metal. However, the thermal conductivity of the graphite film (A) of the present invention is high, and thus the present invention can prevent the target from becoming a high temperature and an oxide having a low melting point can also be used as a starting material for producing a radioactive substance. This is one of the great advantages of the present invention. Natural molybdenum-100 may be used since molybdenum-100 exists in nature, and the starting material for manufacturing a radioactive substance may contain a molybdenum isotope metal and/or an oxide of a molybdenum isotope since molybdenum isotopes other than molybdenum-100 are present in natural molybdenum-100. Those having a high ratio of molybdenum-100 are preferable from the viewpoint of production efficiency of a radioactive substance, and thus those with an increased ratio of molybdenum-100 obtained by concentrating natural molybdenum-100 may be used.

A thickness of the layer of a starting material for producing a radioactive substance (B) is preferably 2 μm or more, more preferably 3 μm or more, still more preferably 5 μm or more, and preferably 30 μm or less, more preferably 25 μm or less, and still more preferably 15 μm or less.

(3) Metal Layer (C)

The target of the present invention is a laminate of the graphite film (A) and the layer of a starting material for producing a radioactive substance (B), but the graphite film (A) and the layer of a starting material for producing a radioactive substance (B) are preferably laminated with a metal layer (C) interposed therebetween. When the target is irradiated with a high energy beam and temporarily heated to a high temperature, there is the danger that the graphite film (A) and the layer of a starting material for producing a radioactive substance (B) react with each other. Hence, the metal layer (C) is preferably formed between the graphite film (A) and the layer of a starting material for producing a radioactive substance (B). The material for the metal layer (C) is preferably at least one selected from a group consisting of aluminum, titanium, nickel, iron, copper, tantalum, tungsten, gold, silver, platinum, and ruthenium and more preferably gold, nickel, titanium, or tantalum.

A thickness of the metal layer (C) is, for example, preferably 10 nm or more and more preferably 30 nm or more from the viewpoint of suppressing the reaction between the graphite film (A) and the layer of a starting material for producing a radioactive substance (B). On the other hand, when the thickness of the metal layer (C) is too thick, heat is stored between the metal layer (C) and the layer of a starting material for producing a radioactive substance (B), and there is the danger that deformation of the target is caused. Consequently, the metal layer (C) is preferably 1 μm or less, more preferably 0.5 μm or less, and still more preferably 0.25 μm or less.

The target of the present invention is arranged on an orbit of a neutron beam or proton beam accelerated using an accelerator, and a starting material for producing a radioactive substance on the target is irradiated with the neutron beam or proton beam to produce a radioactive substance. When the starting material is irradiated with a neutron beam, for example, a (n, 2n) reaction in which two neutrons are released from one neutron takes place. In addition, when the starting material is irradiated with a proton beam, for example, a (p, 2n) reaction in which two neutrons are released from one proton takes place. The target may be irradiated with the neutron beam or proton beam from the substrate side or from the side of the layer of a starting material for producing a radioactive substance. Moreover, the rotating target is preferably irradiated with a beam. Examples of a shape of the target in a direction perpendicular to a beam irradiation direction include a circular shape, an elliptical shape, and a rectangular shape, and a circular shape is preferable. The circular shape means that an outer periphery of the charge conversion film has a circular shape and includes, for example, a shape (donut shape) in which the vicinity of the center of a circle is cut as well.

Next, a method for producing the target of the present invention will be described in the order of a method for producing the graphite film (A) and a method for laminating the layer of a starting material for producing a radioactive substance (B).

The graphite film (A) can be produced by a polymer annealing method in which a predetermined film of a polymer starting material is subjected a heat treatment in an inert gas atmosphere.

Polymer Starting Material

The polymer starting material to be preferably used as a starting material for the graphite film (A) is an aromatic polymer (particularly a heat resistant aromatic polymer). The aromatic polymer is preferably at least one selected from polyamide, polyimide, polyquinoxaline, polyparaphenylene vinylene, polyoxadiazole, polybenzimidazole, polybenzoxazole, polybenzthiazole, polyquinazolinedione, polybenzoxazinone, polyquinazolone, benzimidazobenzophenanthroline ladder polymer, or any derivative thereof. Films formed of these polymer starting materials may be produced by known production methods. As particularly preferred polymer starting materials, aromatic polyimide, polyparaphenylene vinylene, and polyparaphenylene oxadiazole can be exemplified. In particular, aromatic polyimide is preferable. Among these, aromatic polyimide which is described below and produced from an acid dianhydride (particularly an aromatic acid dianhydride) and a diamine (particularly an aromatic diamine) via a polyamic acid is particularly preferable as the polymer starting material for the graphite film (A).

Examples of the acid dianhydride which can be used in a synthesis of the aromatic polyimide include pyromellitic dianhydride, 2,3,6,7-naphthalenetetracarboxylic dianhydride, 3,3′,4,4′-biphenyltetracarboxylic dianhydride, 1,2,5,6-naphthalenetetracarboxylic dianhydride, 2,2′,3,3′-biphenyltetracarboxylic dianhydride, 3,3′,4,4′-benzophenonetetracarboxylic dianhydride, 2,2-bis(3,4-dicarboxyphenyl)propane dianhydride, 3,4,9,10-perylenetetracarboxylic dianhydride, bis(3,4-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)ethane dianhydride, oxydiphthalic dianhydride, bis(3,4-dicarboxyphenyl)sulfone dianhydride, p-phenylenebis(trimellitic acid monoester acid anhydride), ethylene bis(trimellitic acid monoester acid anhydride), bisphenol A bis(trimellitic acid monoester acid anhydride), and analogues thereof. These can be used singly or in mixture at arbitrary proportions. Pyromellitic dianhydride and 3,3′,4,4′-biphenyltetracarboxylic dianhydride are particularly preferable from the viewpoint that an orientation of the polyimide film is higher as the polyimide film has a polymer structure with a significantly rigid structure in particular and the viewpoint of availability.

Examples of the diamine which can be used in a synthesis of the aromatic polyimide include 4,4′-diaminodiphenyl ether, p-phenylenediamine, 4,4′-diaminodiphenylpropane, 4,4′-diaminodiphenvlmethane, benzidine, 3,3′-dichorobenzidine, 4,4′-diaminodiphenyl sulfide, 3,3′-diaminodiphenyl sulfone, 4,4′-diaminodiphenyl sulfone, 4,4′-diaminodiphenyl ether, 3,3′-diaminodiphenvl ether, 3,4′-diaminodiphenyl ether, 1,5-diaminonaphthalene, 4,4′-diaminodiphenyldiethylsilane, 4,4′-diaminodiphenylsilane, 4,4′-diaminodiphenylethylphosphine oxide, 4,4′-diaminodiphenyl N-methylamine, 4,4′-diaminodiphenyl N-phenylamine, 1,4-diaminobenzene(p-phenylenediamine), 1,3-diaminobenzene, 1,2-diaminobenzene, and analogues thereof. These can be used singly or in mixture at arbitrary proportions. Furthermore, it is particularly preferable to synthesize the aromatic polyimide using 4,4′-diaminodiphenyl ether and p-phenylenediamine as starting materials from the viewpoint of enhancing an orientation of the polyimide film and the viewpoint of availability.

A known method can be used to prepare a polyamic acid from the acid dianhydride and the diamine. Usually, at least one acid dianhydride and at least one diamine are dissolved in an organic solvent, and the solution of a polyamic acid in an organic solvent obtained is stirred under a controlled temperature condition until a polymerization of the acid dianhydride and the diamine is completed to produce a polyamic acid. These polyamic acid solutions are usually obtained at a concentration of 5 to 35% by mass and preferably 10 to 30% by mass. A proper molecular weight and a proper solution viscosity can be attained in a case in which the concentration is in this range. The acid dianhydride and the diamine in the starting material solution are preferably set to be in substantially equimolar amounts. A molar ratio (acid dianhydride/diamine) of the acid dianhydride to the diamine is, for example, 1.5/1 to 1/1.5, preferably 1.2/1 to 1/1.2, and more preferably 1.1/1 to 1/1.1.

Synthesis of Film of Polymer Starting Material and Film Formation

The film of polymer starting material can be produced from the polymer starting material or a synthetic starting material thereof by various known methods. For example, as a method for producing the polyimide, there are a thermal curing method in which a polyamic acid as a precursor is converted to an imide by heating and a chemical curing method in which a polyamic acid is converted to an imide using dehydrating agents typified by acid anhydrides such as acetic anhydride and tertiary amines such as picoline, quinoline, isoquinoline, and pyridine as imidization accelerating agents. Either of these may be used. The chemical curing method is preferable from the viewpoint that the film to be obtained has a small coefficient of linear expansion, a high elastic modulus, and a high birefringence and is not fractured even if tension is applied thereto during the firing and high quality graphite can be obtained. The chemical curing method is also excellent from the perspective of improving the thermal conductivity of graphite.

The polyimide film is produced by flow casting, drying, and imidizing a solution of a polyamic acid which is the polyimide precursor in an organic solvent on a support such as an endless belt or a stainless drum. Specifically, a method for producing a film by chemical curing is as follows. First, a stoichiometric amount or more of a dehydrating agent and a catalytic amount of an imidization accelerating agent are added to the polyamic acid solution, the mixture is flow cast or applied on a support plate, an organic film such as PET, or a support such as a drum or an endless belt to be formed into a film shape, and the organic solvent is evaporated to obtain a film having self-supporting property. Subsequently, this is imidized while being further heated and dried to obtain a polyimide film. A temperature at the time of heating is preferably in a range of 120° C. to 550° C. Furthermore, a step of fixing or stretching the film is preferably included in order to prevent shrinkage during the polyimide production process. A carbon molecules in a graphite precursor are required to be rearranged in order to smoothly advance a graphitization reaction. If the step of fixing or stretching the film described above is performed, a polyimide film in which the molecular structure and the higher order structure thereof are controlled can be obtained, the rearrangement of carbon molecules is minimized, and thus it is presumed that a conversion of the graphite precursor to graphite is likely to proceed even at a low temperature.

In a preferred aspect of the graphite film (A) in the target of the present invention, the thickness of the graphite film (A) is 0.1 to 50 μm. In order to obtain the graphite film (A) in the above range, a thickness of a film of the polymer starting material is preferably in a range of 0.2 to 100 μm in the case of an aromatic polyimide. This is because the thickness of the graphite to be finally obtained generally depends on the thickness of the film of polymer starting material and the thickness of the graphite to be obtained in the course of the primary heat treatment and the secondary heat treatment (to be described later) is about ½ of the thickness of the starting material polymer.

Carbonization (Primary Heat Treatment) and Secondary Heat Treatment

Next, methods of carbonization (primary heat treatment) and secondary heat treatment of the film of the polymer starting material typified by polyimide will be described. In the present invention, the film of the polymer starting material as a starting material, is subjected to the primary heat treatment in an inert gas or a vacuum to be carbonized. As the inert gas, nitrogen, argon, or a mixed gas of argon and nitrogen is preferably used. The primary heat treatment is preferably performed at 500° C. or higher, more preferably 600° C. or higher, still more preferably 700° C. or higher, and particularly preferably 1000° C. or higher. The primary heat treatment may be performed for about 0.5 to 3 hours, for example. A heating rate to the primary heat treatment is not particularly limited but can be, for example, 5 to 15° C./min. A pressure may be applied in a direction perpendicular to the film surface to the extent in which destruction of the film is not caused or a tensile force may be applied in a direction parallel to the film surface so that an orientation of the film of the starting polymer is not lost in the primary heat treatment stage.

The film carbonized by the above method is set in a high temperature furnace and subjected to the secondary heat treatment. In the secondary heat treatment, the carbonized film may be once taken out and transferred to the furnace for the secondary heat treatment and then the secondary heat treatment may be performed, or the carbonization and the secondary heat treatment may be continuously performed. In the secondary heat treatment, graphitization is preferably performed. The carbonized film is preferably set to be interposed between a CIP (Cold Isostatic Pressing) material and a glassy carbon substrate. The secondary heat treatment is preferably performed at 2400° C. or higher, more preferably 2900° C. or higher, and most preferably 3000° C. or higher. This makes it possible to improve the thermal conductivity in the film surface direction of the graphite to be obtained. This treatment temperature may be the highest treatment temperature in the secondary heat treatment process or the graphite obtained may be subjected to a heat treatment again in the form of annealing. In order to realize such a high temperature, an electric current is usually allowed to directly flow to the graphite heater and heating is performed utilizing the Joule heat thereof. The secondary heat treatment is performed in an inert gas. Argon is most suitable as the inert gas, and a small amount of helium may be added to argon. The graphite precursor can be converted to higher quality graphite as the treatment temperature is higher, but graphite having an excellent thermal conductivity can be obtained, for example, even when the treatment temperature is 3700° C. or lower, particularly 3600° C. or lower, or 3500° C. or lower.

A heating rate from the primary heat treatment temperature to the secondary heat treatment temperature can be, for example, 1 to 25° C./min. A retention time at the secondary heat treatment temperature is, for example, 10 minutes or more and preferably 30 minutes or more and may be 1 hour or more. The upper limit of the retention time is not particularly limited but may be usually 10 hours or less and particularly 5 hours or less. At the time of the secondary heat treatment, a pressure may be applied in the film thickness direction or tensile force may be applied in a direction parallel to the film surface. As the method for applying a pressure, methods such as mechanical pressing and pressing using a weight can be adopted singly or in combination. An atmosphere in the high temperature furnace is preferably pressurized by the inert gas in a case in which the heat treatment is performed at a temperature of 3000° C. or higher. When the heat treatment temperature is high, sublimation of carbon starts from the film surface and deterioration phenomena such as holes on the film surface, expansion of cracking, and thinning occur. Such deterioration phenomena can be prevented and an excellent film (particularly a graphite film) can be obtained as the atmosphere is pressurized. A pressure (gauge pressure) of the atmosphere in the high temperature furnace by the inert gas is, for example, 0.05 MPa or more, preferably 0.10 MPa or more, and still more preferably 0.14 MPa or more. The upper limit of this atmosphere pressure is not particularly limited but may be, for example, 2 MPa or less and particularly 1.8 MPa or less. After the heat treatment, the temperature may be lowered at a rate of, for example, 30 to 50° C./min. According to such a method, it is considered that a favorable graphite crystal structure can be formed, and as a result, a graphite film exhibiting excellent thermal conductivity can be obtained.

A method for laminating the starting material for producing a radioactive substance on the graphite film (A) is not particularly limited, and usual thin film forming means such as a sputtering method, a vapor deposition method, an electron beam vapor deposition method, and an electrodeposition (electrophoretic electrodeposition) method can be adopted. The methods may be used singly or in combination. The electrodeposition method is preferable in that the valuable starting material for producing a radioactive substance can be used without waste and the recovery operation of the residual starting material is significantly simple. In Non-Patent Document 2, it is described that the target produced by the electrodeposition method is deformed after being irradiated with a beam. However, according to the present invention, the graphite film (A) having a high thermal conductivity is used as the target substrate and thus deformation of the target due to heat can be prevented even in a case in which the target is produced by the electrodeposition method. The electrodeposition method (electrophoretic electrodeposition method) is a method for depositing a metal and the like on a substrate from a metal starting material dissolved in a solvent by a direct current electric field. As the metal starting material, an ammonium salt, sodium salt, ethylenediamine salt, aniline salt, potassium salt, tetramethylammonium salt, or tetrabutylammonium salt of an oxoanion of a metal (for example, molybdenum-100) can be used. As the solvent, a water-based solvent, an alcohol-based solvent, a ketone-based solvent and the like can be used. The solvent preferably contains ammonium acetate, sulfuric acid, oxalic acid, chromic acid, boric acid, sodium phosphate, or the like as an electrolytic solution. A metal to be a starting material for producing a radioactive substance can be laminated on a graphite film of a cathode by immersing the graphite film (A) as the cathode and a platinum electrode as an anode in a solvent in which the metal starting material is dissolved and allowing an electric current to flow between the two electrodes. A current density is, for example, 0.1 to 1 A/cm² (preferably 0.2 to 0.5 A/cm²), and the treatment is preferably performed for 10 to 180 minutes (preferably 20 to 120 minutes).

It is also preferable to form the metal layer (C) on the graphite film (A) and then to form the layer of a starting material for producing a radioactive substance (B) on the metal layer (C). A method for forming the metal layer (C) is not particularly limited, and thin film forming methods to be commonly used such as a vapor deposition method, a sputtering method, an EB (electron beam) vapor deposition method, an ion plating method, and a plating method can be used.

This application claims the benefit of priority based on the Japanese Patent Application No. 2017-114328 filed on Jun. 9, 2017. The entire contents of the Japanese Patent Application No. 2017-114328 filed on Jun. 9, 2017 are incorporated herein by reference.

### EXAMPLES

Hereinafter, the present invention will be more specifically described with reference to Examples. The present invention is not limited by the following Examples, and can of course be implemented with appropriate modifications within a range that can be adapted to the gist described above and to be described later, and these are all included in the technical scope of the present invention.

The film thickness, thermal conductivity, density, tensile strength, and Raman intensity ratio of the graphite films obtained in the following Production Examples were measured by the methods described above. The samples after forming a molybdenum layer on a graphite film were also measured according to the same procedure, and the thickness of the molybdenum layer was calculated by subtracting the thickness of the graphite film from the thickness of the sample after forming the molybdenum layer.

### Production Examples 1 to 13

### Production of Support Substrate (Graphite Film (A)) for Layer of Starting Material for Producing Radioactive Substance

A support substrate composed of a graphite film was produced by a polymer annealing method according to the following procedure. First, a curing agent composed of 20 g of acetic anhydride and 10 g of isoquinoline was mixed to 100 g of a 18% by mass DMF (N,N-dimethylformamide) solution of a polyamic acid synthesized from a mixture containing pyromellitic dianhydride (PMDA) as an acid dianhydride and 4,4′-diaminodiphenyl ether (ODA) as a diamine at a proportion of 1/1.1 (PDMA/ODA) as a molar ratio as a starting material, and stirred. The resultant mixture was subjected to defoaming by centrifugation and then flow cast on an aluminum foil. The process from stirring to defoaming was performed while cooling the mixture to 0° C. This laminate of an aluminum foil and a polyamic acid solution was heated at 120° C. for 150 seconds, at 300° C. for 30 seconds, at 400° C. for 30 seconds, and at 500° C. for 30 seconds. Thereafter, the aluminum foil was removed from the laminate to produce polyimide films having different thicknesses. The thickness of the polyimide film was adjusted in a range of 0.4 to 75 μm by the casting speed and the like.

The obtained polyimide film was heated to 1000° C. at a rate of 10° C./min in a nitrogen gas atmosphere and carbonized (primary heat treatment) at 1000° C. or higher for 1 hour. Thereafter, the aromatic polyimide was graphitized by being annealed at from 2400° C. to 3000° C. (highest temperature in the secondary heat treatment) at a gauge pressure of 0.1 MPa in argon gas, thereby obtaining a graphite film having a thickness of 40 to 0.14 μm. A heating rate from the primary heat treatment to the secondary heat treatment was 20° C./min, and the temperature was lowered to room temperature at a rate of 40° C./min after the secondary heat treatment. The physical properties of the graphite films obtained are shown in Table 1. The thermal conductivities of the graphite films obtained in the direction parallel to the a-b plane at 25° C. were all 500 W/mK or more. The densities thereof were also all 1.8 g/cm³ or more.

### Production Example 14

### Production of Support Substrate (Graphite Film (A)) for Layer of Starting Material for Producing Radioactive Substance

A graphite film having a thickness of 2.9 μm was produced in the same manner as in Production Examples 1 to 13 except that the highest temperature was set to 2200° C. The respective physical properties of the produced graphite film are presented in Table 1.

Production of Target by Electrodeposition Method

### Examples 1 to 12

As a substrate for supporting the target, the graphite films which had a thickness of 0.14 to 40 μm and were obtained in Production Examples 1 to 12 were cut into a size of 20 mm×40 mm, and the cut graphite films were set on a PTFE frame dedicated to electrodeposition experiment so that only one surface to be subjected to electrodeposition was exposed. Ammonium acetate (20 g, 260 mmol) and ammonium molybdate (250 mg, 1.0 mmol) were dissolved in 25 ml of water to obtain a solution. The solution was placed in a glass container dedicated to electrodeposition experiment, and then a platinum electrode (25×70 mm) as an anode and a graphite film (work space, 10×30 mm) as a cathode were placed in the solution in parallel at a distance of 4 cm from each other. These electrodes were attached to a potentiostat (HA-3001A manufactured by HOKUTO DENKO CORPORATION) and the reaction was performed at a current density of 0.2 to 0.3 A/cm² for 20 to 120 minutes. Thereafter, the cathode side (namely, the graphite film) was removed and washed with ion exchanged water, and then dried at 100° C. in a vacuum, thereby producing a target in which a molybdenum layer having a thickness of 3.2 to 21 μm was formed on a graphite film. The thickness of the produced molybdenum layer is shown in Table 1.

### Example 13

The graphite film which had a thickness of 2.2 μm and was obtained in Production Example 13 was attached to a small vacuum deposition apparatus (VTR-350/ERH manufactured by ULVAC KIKO Inc.). Thereafter, a gold layer (corresponding to the metal layer (C)) having a thickness of 50 nm was formed on the graphite film by a vacuum deposition method. A molybdenum layer was formed on the metal layer (C) side of the graphite film on which the metal layer (C) was laminated in the same manner as in Examples 1 to 12. The thickness of the molybdenum layer is as shown in Table 1.

### Comparative Example 1

A carbon film having a thickness of 14 μm (manufactured by The Arizona Carbon Foil Co., Inc., PCG, vapor deposition film) was cut into the same size as in Examples 1 to 12 instead of the graphite film, and the cut carbon film was set on a frame dedicated to electrodeposition experiment. Thereafter, it was attempted to form a molybdenum layer on the carbon film by an electrodeposition method in the same manner as in Examples 1 to 12, but the carbon film was fractured when the carbon film was set as a cathode, and the molybdenum layer was not able to be produced by the electrodeposition method. The physical properties of the carbon film used in Comparative Example 1 are as shown in Table 1.

### Comparative Example 2

A graphite film having a thickness of 130 μm (manufactured by Alfa Aesar, Graphite foil, density: 1.1 g/cm³) was set on a frame dedicated to electrodeposition experiment instead of the graphite films of Examples 1 to 12 in the same manner as in Examples 1 to 12. Thereafter, it was attempted to form a ¹⁰⁰Mo film on the graphite film by an electrodeposition method in the same manner as in Examples 1 to 12, but the graphite film peeled off during film formation, and a target in which ¹⁰⁰Mo and graphite were laminated can't be obtained.

### Comparative Example 3

A molybdenum layer was formed on the graphite film in the same manner as in Examples 1 to 12 except that the graphite film produced in Production Example 14 was used. The thickness of the produced molybdenum layer is shown in Table 1.

Heat Resistance Test by Electric Heating Method

The laminates of graphite (or carbon film) and molybdenum obtained in Examples 1 to 13 and Comparative Example 3 were set in the heat resistance testing apparatus illustrated in FIG. 2. In the heat resistance testing apparatus illustrated in FIG. 2, two graphite electrodes 22 are set inside a stainless steel vacuum container 24 and a sample (the laminate) 21 is set between the graphite electrodes 22. An internal pressure of the vacuum container 24 was set to about 1 Pa using a vacuum pump 25, then a direct current was applied to the electrodes by a direct current power source 23, and a central portion 26 of the sample was heated to 800° C. while being monitored by a radiation thermometer 27 (IR-CAI manufactured by CHINO CORPORATION). The heated sample was retained at 800° C. for 1 hour, the electric current was cut off, and the sample was cooled to room temperature. After being cooled, the sample was taken out from the apparatus, and whether or not the sample was fractured was confirmed. The results are shown in Table 1.

TABLE 1

| | | | | | | Layer of a | | | | | |
|---|---|---|---|---|---|---|---|---|---|---|---|
| | Graphite film(A) | | | | | starting material | | | | | |
| | | Highest | | | | for producing | | | | | |
| | | temperature | | | | a radioactive | | Measure- | | | |
| | | in secondary | | Thermal | | substance | | ment of | Raman | Electrode- | Heat |
| | | heat | | Conduc- | | (B) | Metal | tensile | spectrume | position | resis- |
| | Production | treatment | Thickness | tivity | Density | Thickness | layer | strength | ratio | experi- | tance |
| Examples | No. | (° C.) | (μm) | (W/mK) | (g/cm³) | (μm) | (C) | (MPa) | (RG/RC) | ment | testing |
| Example 1 | Production | 3000 | 40 | 1500 | 1.90 | 21 | — | 27 | >99 | ⊚ | ⊚ |
| | Example 1 | | | | | | | | | | |
| Example 2 | Production | 3000 | 25 | 1700 | 2.00 | 20 | — | 32 | >99 | ⊚ | ⊚ |
| | Example 2 | | | | | | | | | | |
| Example 3 | Production | 3000 | 9.6 | 1900 | 2.05 | 9.2 | — | 41 | >99 | ⊚ | ⊚ |
| | Example 3 | | | | | | | | | | |
| Example 4 | Production | 3000 | 4.7 | 1950 | 2.07 | 6.2 | — | 32 | >99 | ⊚ | ⊚ |
| | Example 4 | | | | | | | | | | |
| Example 5 | Production | 3000 | 2.1 | 2000 | 2.11 | 7.4 | — | 15 | >99 | ⊚ | ⊚ |
| | Example 5 | | | | | | | | | | |
| Example 6 | Production | 3000 | 1.2 | 2000 | 2.22 | 5.1 | — | 13 | >99 | ⊚ | ⊚ |
| | Example 6 | | | | | | | | | | |
| Example 7 | Production | 3000 | 0.72 | 1950 | 2.22 | 3.4 | — | 12 | >99 | ⊚ | ⊚ |
| | Example 7 | | | | | | | | | | |
| Example 8 | Production | 3000 | 0.31 | 1980 | 2.20 | 3.2 | — | 10 | >99 | ⊚ | ⊚ |
| | Example 8 | | | | | | | | | | |
| Example 9 | Production | 3000 | 0.14 | 1920 | 2.21 | 3.3 | — | 9 | >99 | ⊚ | ⊚ |
| | Example 9 | | | | | | | | | | |
| Example 10 | Production | 2800 | 2.1 | 1600 | 2.00 | 7.0 | | 14 | >99 | ⊚ | ⊚ |
| | Example 10 | | | | | | | | | | |
| Example 11 | Production | 2600 | 2.2 | 1200 | 1.90 | 7.3 | — | 16 | 10 | ⊚ | ⊚ |
| | Example 11 | | | | | | | | | | |
| Example 12 | Production | 2400 | 2.2 | 800 | 1.82 | 7.3 | — | 11 | 4 | ⊚ | ⊚ |
| | Example 12 | | | | | | | | | | |
| Example 13 | Production | 3000 | 2.2 | 2000 | 2.11 | 7.2 | Au | 14 | >99 | ⊚ | ⊚ |
| | Example 13 | | | | | | (50 nm) | | | | |
| Comparative | — | — | 14 | 13 | about 2 | — | — | — | 0.9 | X | — |
| Example 1 | | | | | | | | | | | |
| Comparative | — | — | 130 | 200 | 1.1 | — | — | 5 | >99 | X | — |
| Example 2 | | | | | | | | | | | |
| Comparative | Production | 2200 | 2.9 | 300 | 1.60 | 7.6 | | 11 | 0.8 | ⊚ | X |
| Example 3 | Example 14 | | | | | | | | | | |

⊚: good,
X: fractured,
—: not. included or inoperative

In Examples 1 to 13 in which the thermal conductivity of the graphite film in the direction parallel to the a-b plane of the graphite layer at 25° C. was 500 W/mK or more, the deformation of the sample after the heat resistance test was not confirmed and also the molybdenum layer was able to be laminated by the electrodeposition method. Consequently, it is considered that the laminates of Examples 1 to 13 are not deformed by the heat generated by beam irradiation even when being used as a proton-beam or neutron-beam target. Moreover, a target for proton-beam or neutron-beam can be easily produced by an electrodeposition method.

On the other hand, in Comparative Example 3, the central portion of the sample was deformed after the heat resistance test. It is presumed that this is because the thermal conductivity of the graphite film was low, thus the heat was accumulated in the central portion of the sample, and the target was partially deformed. In addition, in Comparative Examples 1 and 2, it was not possible to apply electrodeposition and to perform the heat resistance test, but the heat resistance is considered to be low as in Comparative Example 3 when the thermal conductivity of the carbon films or graphite film of Comparative Examples 1 and 2 are taken into consideration.

### INDUSTRIAL APPLICABILITY

The laminate of the graphite film (A) and the layer of a starting material for producing a radioactive substance (B) in the present invention exhibits excellent heat resistance, thus can quickly diffuse the heat generated by proton-beam or neutron-beam irradiation, and is useful as a target for proton-beam or neutron-beam.

### DESCRIPTION OF REFERENCE SIGNS

11 graphite film (A)
12 layer of starting material for producing radioactive substance (B)
13 metal layer (C)
21 sample
22 graphite electrode
23 direct current power source
24 vacuum container
25 vacuum pump
26 central portion of sample
27 radiation thermometer

1. A target for proton-beam or neutron-beam irradiation, comprising:
a graphite film (A) having a thermal conductivity of 500 W/mK or more at 25° C. in a direction parallel to an a-b plane of a graphite layer; and
a layer (B) of a starting material for producing a radioactive substance,
wherein the target is a laminate of the graphite film (A) and the layer (B).

2. The target according to claim 1, wherein a density of the graphite film (A) is 1.8 to 2.26 g/cm³.

3. The target according to claim 1, wherein a tensile strength of the graphite film (A) is 5 MPa or more.

4. The target according to claim 1,
wherein a ratio RG/RC is 4 or more, and
wherein RG is a Raman band intensity appearing at 1575 to 1600 cm⁻¹ and RC is a Raman band intensity appearing at 1330 to 1360 cm⁻¹, each obtained from a measurement of the graphite film (A) by Raman spectroscopy.

5. The target according to claim 1, wherein a thickness of the graphite film (A) is 0.1 to 50 μm.

6. The target according to claim 1, wherein the starting material is a metal and/or a metal oxide.

7. The target according to claim 1, wherein the starting material is molybdenum-100 metal and/or an oxide of molybdenum-100 metal.

8. The target according to claim 7, wherein the starting material further comprises a molybdenum isotope metal and/or an oxide of a molybdenum isotope.

9. The target according to claim 1, further comprising a metal layer (C), wherein the graphite film (A) and the layer (B) are laminated via the metal layer (C).

10. The target according to claim 9, wherein the metal layer (C) is at least one selected from the group consisting of aluminum, titanium, nickel, iron, copper, tantalum, tungsten, gold, silver, platinum, and ruthenium.

11. The target according to claim 9, wherein a thickness of the metal layer (C) is 1 μm or less.

12. A method for generating a radioactive substance, comprising irradiating the target according to claim 1 with a proton beam or a neutron beam.
